(19) United States
(12) Patent Application Publication
(10) Pub. No.: US 2012/0096302 A1
(43) Pub. Date: Apr. 19, 2012

(54) FIELD DEVICE HAVING A REAL TIME CLOCK

(75) Inventors: Stefan TABELANDER, Herford (DE); Thomas Kleegrewe, Minden (DE)

(73) Assignee: ABB Technology AG, Zurich (CH)

(21) Appl. No.: 13/163,321

(22) Filed: Jun. 17, 2011

(30) Foreign Application Priority Data
Jun. 17, 2010 (DE) 10 2010 024 210.1

(51) Int. Cl. G06F 1/04

(52) U.S. Cl. 713/600

(57) ABSTRACT

A field device includes a real time clock, and at least one communication interface for at least unidirectionally, receiving and transmitting data. The real time clock is detachably connected to the at least one receiving communication interface of the field device, and includes a power supply.

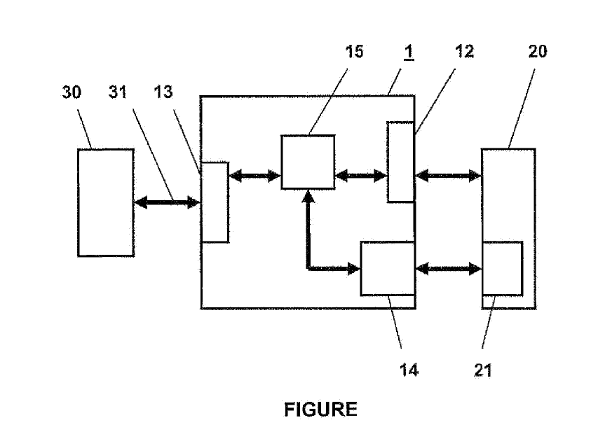

### RELATED APPLICATION

This application claims priority under 35 U.S.C. §119 to German Patent Application No. DE 10 2010 024 210.1 filed in Germany on Jun. 17, 2010, the entire content of which is hereby incorporated by reference in its entirety.

### FIELD

The disclosure relates to field devices, such as, a field device having a real time clock, electropneumatic position regulators, actuating drives, measuring converters for conversion of a physical variable to an electrical variable having a communication interface such as HART, Modbus, Profibus PA, Profibus DP-V1, Profibus DP-V2, Foundation Fieldbus H1/HSE, existing wireless solutions, and local communication interfaces, (e.g., human machine interface—HMI).

### BACKGROUND INFORMATION

In process installations having a multiplicity of field devices, it is important to know, and particularly in the event of disturbances, at what time each measured value or manipulated variable has been processed and by which field device. For this purpose, the measured values and manipulated variables are provided with time stamps, which normally comprise the respective date and the time.

In known systems, many specifications for field device communication specify data formats for time and date information. One example of this is HART 7 or Profibus DP-V2. These data types can specify a suitable time base of some type as desired. A time base such as this, which in known field devices is derived from the microcontroller/processor clock, has prominent disadvantages, however.

For example, despite the clock signal being relatively highly stable, its accuracy is on the order of magnitude of, for example, about 10 minutes/year. However, this level of accuracy is not sufficient for some applications, particularly for fault tracing. Furthermore, the stability of the clock signal is influenced by the temperature and other external conditions, which can make this accuracy even worse.

Greater accuracy is achieved by so-called real time clocks which are a component, that is already known per se, of microprocessors such as the Renesas R32C/87. The accuracy of these real time clocks is in the acceptable range of seconds/year.

However, in conventional practice, so-called two-conductor appliances in field devices which are supplied via a fieldbus often for energy reasons, use only those microcontrollers which do not have their own real time clock. Analog 4-20 mA appliances with HART communication have the lowest energy feed thereof.

A further disadvantage results from the type of power supply for the time base. When the microcontroller system is disconnected from the power supply, no clock is any longer produced and, since the microcontroller is no longer operating, the time base cannot be maintained. In consequence, a previously set time/date is lost, and must be reset after restarting. However, this is not done in practical use.

Although technical solutions for feeding electronic devices during supply gaps in the form of large charge stores such as batteries, high-capacitance capacitors (Gold-caps, PSR capacitors) or rechargeable batteries are known, in field devices which are used in explosion-hazard atmospheres, these have to comply with relevant standards such as ATEX, IEC Ex, FM/CSA or the like, however. Therefore, energy stores such as batteries must not produce heating which could cause ignition, and their current must be limited.

The charging current which is additionally specified for charging the store should not adversely affect the actual operation of the appliance. This is particularly the case when the electrical energy supplied to the appliance is just sufficient to operate the appliance, but is not sufficient for charging. In this case, circuitry and logic energy management concepts must be provided.

The implementation of these measures and the material price for energy stores and real time clocks can be so costly that implementation in a standard appliance is uncompetitive.

Furthermore, the measures specified for explosion protection can represent a major restriction on the main electronics or in the overall appliance context, which are evident in compliance with particularly large separations, installation measures and appliance height.

### SUMMARY

An exemplary field device is disclosed. The field device comprising a real time clock; and at least one communication interface for at least unidirectionally receiving data, wherein the real time clock, has a power supply, and is detachably connected to the at least one receiving communication interface of the field device.

### BRIEF DESCRIPTION OF THE DRAWING

Additional refinements, advantages and features of the present disclosure are described in more detail below with reference to exemplary embodiments illustrated in the drawings, in which:

The FIGURE illustrates a field device in accordance with an exemplary embodiment.

### DETAILED DESCRIPTION

Exemplary embodiments of the present disclosure are based on specifying a field device having a real time clock, which can be used in explosion-hazard atmospheres and is largely independent of any external feed.

An exemplary embodiment of the present disclosure is directed to an exemplary field device having at least one communication interface for at unidirectionally receiving data.

According to an exemplary embodiment of the present disclosure, a real time clock, which is known per se and has its own power supply, can be detachably connected to the at least one receiving communication interface of the field device.

A sufficiently accurate time base for time stamping of measured values and/or manipulated variables is therefore available to the field device, and also does not load the energy budget of so-called two-conductor appliances.

Advantageously at least one of plural field devices can suitably be equipped with this real time clock, thus allowing every field device in a system to be suitably designed for this specification. This specification can prevent every field device version from being loaded with the cost of a real time clock.

The separation between the power supply for the real time clock and the power supply for the field device advantageously maintains the functionality and accuracy of the real time clock even after the feed to the field device has failed. This makes it possible to correctly record at least the time when the field device starts up again after failure of the power supply.

Furthermore, the disclosure allows deterministic procedures for successive actions in different field devices, in particular actuating appliances, by applying time information to each command in the command sequence with defining the time at which the respective command is to be carried out.

In another exemplary embodiment of the present disclosure, the communication interface between the field device and the real time clock is designed for bidirectional data interchange, and the real time clock can be synchronized with a time base of a superordinate device.

In another exemplary embodiment of the present disclosure, the real time clock can be equipped with a rechargeable energy store, which can be charged from the excess energy which is not to be used by the field device. For this purpose, the field device has a charging regulator which determines the energy that is not to be used by the field device and charges the rechargeable energy store for the real time clock.

The power supply for the real time clock advantageously specifies no maintenance. Furthermore, the energy store for the real time clock can be used to temporarily feed the field device or parts of it when its power supply fails.

Further advantageous refinements of the exemplary embodiments can be found in disclosure that follows. The FIGURE illustrates a field device in accordance with an exemplary embodiment. In the core, the field device 1 has a microcontroller 15 which is connected to a superordinate device 30 via a first communication interface 13 and a communication link 31.

In an exemplary embodiment, the communication link 31 consists of a two-wire line. In this case, both data interchange and the power supply for the field device 1 can be provided via this two-wire line.

In another exemplary embodiment, the communication link 31 is wire-free, and preferably radio-based.

The microcontroller 15 can be detachably connected to a real time clock 20 via a second communication interface 12. The real time clock 20 is preferably in the form of a plug-in module. The real time clock 20 can have its own power supply 21. In the simplest embodiment, the power supply 21 is performed by a battery. In one embodiment of the disclosure, the power supply 21 is in the form of a rechargeable energy store—in the form of a rechargeable battery or a high-capacitance capacitor, a so-called Gold-Cap or PSR capacitor.

Furthermore, the field device 1 can be equipped with a charging regulator 14. The charging regulator 14 can be connected to the rechargeable energy store for the real time clock 20 such that excess energy which is not to be used by the field device is used to charge the rechargeable energy store.

If the feed to the field device 1 fails, it is possible for the rechargeable energy store for the real time clock 20 to be used to temporarily feed the field device 1 or parts of it.

In an alternative embodiment, the real time clock 20 may have a connection for a connecting line which is connected to the rechargeable energy store 21. This allows the energy store 21 to be charged from an external energy source. While the external energy source is available, the real time clock 20 is supplied from it. If the external feed fails, the rechargeable energy store 21 takes over the supply for the real time clock 20 without interruption.

In a further embodiment of the disclosure, the real time clock 20 can be equipped with a non-rechargeable energy store 21.

In one exemplary embodiment of the disclosure, the real time clock 20 can be synchronized with a time base of the superordinate device 30. For this purpose, a time signal is received from the superordinate device 30 via the first communication interface 13, and is passed to the real time clock 20 via the second communication interface 12.

For this purpose, the synchronization can be corrected/matched to a known pattern or variable by means of a predefined feature, such as a known information signal or a pattern or flank at the second communication interface 12 of the field device 1. This type of synchronization is described within the HART 7 specification, see HCF Specification spec151r9.1 Common Practice Command, as command 89, 90.

In one alternative embodiment of the disclosure, the time is set for the real time clock 20 by means of a radio-based method. For this purpose, the real time clock 20 may have a radio clock.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Field device
12, 13 Communication interface
14 Charging regulator
15 Microcontroller
20 Real time clock
21 Power supply
30 Superordinate device
31 Communication link

What is claimed is:

1. A field device comprising:
a real time clock; and
at least one communication interface for at least unidirectionally receiving data, wherein the real time clock, has a power supply, and is detachably connected to the at least one receiving communication interface of the field device.

2. The field device as claimed in claim 1, wherein the communication interface is a bidirectional data interchange between the field device and the real time clock, and the real time clock can be synchronized with a time base of a superordinate device.

3. The field device as claimed in claim 1, wherein the real time clock is includes a rechargeable energy store, which is charged from excess energy not used by the field device.

4. The field device as claimed in claim 3, wherein the field device has a charging regulator which determines the energy not to be used by the field device and charges the rechargeable energy store for the real time clock.

5. The field device as claimed in claim 1, wherein the real time clock includes a non-rechargeable energy store.

6. The field device as claimed in claim 1, wherein the real time clock includes means for external feeding, which provide the supply for the real time clock in parallel with a rechargeable energy store, and wherein, if the external feed fails, the rechargeable energy store takes over the supply, without any interruption.

7. The field device as claimed in claim 1, wherein the real time clock has a radio clock.
